(19) United States
(12) Patent Application Publication
(10) Pub. No.: US 2016/0026659 A1
(43) Pub. Date: Jan. 28, 2016

(54) Centrally Managing Electrical Vehicle Recharging Station Infrastructure Data Using Over-the-Air Telematics Communications

(71) Applicant: GM Global Technology Operations LLC, Detroit, MI (US)

(72) Inventors: Jason A. Harley, Warren, MI (US); Thomas K. Mauti, JR., Lake Orion, MI (US); Alan B. Martin, Washington, MI (US)

(21) Appl. No.: 14/337,947

(22) Filed: Jul. 22, 2014

(51) Int. Cl. G06F 17/30; H04L 29/08

(52) U.S. Cl. CPC G06F 17/30289; H04L 67/10

(57) ABSTRACT

A system and method are described for maintaining a recharging station database for electric vehicles based upon recharging event data provided by electric vehicles equipped with telematics units. The recharging station server computer system is configured to receive recharging event information corresponding to a recharging event for an electric vehicle battery unit by an identified recharger, the recharging event information including at least a measurement relating to an electrical infrastructure providing power to the identified recharger. The system is further configured to process the recharging event information to render a diagnostic result relating to an electrical infrastructure providing power to the identified recharger. The computer system issues an alert based upon a detected condition in the electrical infrastructure during the processing.

### TECHNOLOGY FIELD

The present disclosure relates generally to telematics systems and more specifically to using telematics systems within rechargeable battery-powered vehicles to maintain a database of recharging stations, including state-of-health of an electrical infrastructure supplying power to multiple recharging units/outlets at a given recharging station.

### BACKGROUND

Telematics units within mobile vehicles provide subscribers with connectivity to a telematics service provider (TSP). The TSP provides subscribers with an array of services ranging from emergency call handling and stolen vehicle recovery to diagnostics monitoring and turn-by-turn navigation. Telematics units are provisioned and activated at a point of sale when a subscriber purchases a telematics-equipped vehicle. Upon activation, the telematics unit provides a subscriber with a wide variety of telematics services.

The telematics services provide, among other things, information regarding businesses and amenities located in the vicinity of the user. For example, a TSP permits users to request the location of various service providers located within the vicinity of the users. To facilitate providing such information to users, a TSP obtains maps and information regarding businesses and amenities. The information regarding businesses and amenities is often provided by third party information sources. However, such information sources may not have a satisfactory verification/validation process. Furthermore, third party information sources may not update the provided information as frequently as necessary/desired for providing users of telematics units with reliable aggregated information. The aggregated third party information regarding businesses and related amenities is potentially inaccurate, untimely, and unreliable. As a consequence there may be hesitancy for the TSP to provide the information to users and/or the users to rely upon the aggregated information provided by the TSP.

A current state-of-health (and in general availability) status of an electrical infrastructure for a particular facility for recharging electric vehicles is a particular type of service provider information for which timely, accurate and reliable information is generally desirable. Such recharging facility status information can be highly valuable to users, but only if timely, accurate and reliable. However, TSPs may not be able to adequately serve users if the current state-of-health information is provided to the TSP on an ad hoc basis by recorded personal user observations. Thus, while there is electrical vehicle user demand for state-of-health status information, it is unlikely to be consulted and/or relied upon by users without certain assurances that the information is timely, accurate and reliable. Moreover, without assurances that particular recharging stations are available, it is doubtful that electric vehicles will be relied for long excursions that require at least one mid-trip recharge. Without such capability, electric vehicles are not likely to reach widespread adoption, and will remain a novelty for completing short, local excursions.

### SUMMARY OF THE INVENTION

A method, computer readable medium and system are described for maintaining a recharging station database for electric vehicles based upon recharging event data provided by electric vehicles equipped with telematics units. The recharging station server computer system is configured to receive recharging event information corresponding to a recharging event for an electric vehicle battery unit by an identified recharger, the recharging event information including at least a measurement relating to an electrical infrastructure providing power to the identified recharger. The system is further configured to process the recharging event information to render a diagnostic result relating to an electrical infrastructure providing power to the identified recharger. The computer system issues an alert based upon a detected condition in the electrical infrastructure during the processing.

The invention is further embodied in a non-transitory computer-readable medium including computer executable instructions for configuring a computer system to facilitate maintaining a recharging station database for electric vehicle based upon recharging event data provided by electric vehicles equipped with telematics units.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an operating environment for a mobile vehicle communication system usable in implementations of the described principles;

FIG. 2 is a schematic diagram of an exemplary recharging station, comprising an electrical infrastructure and multiple chargers, usable in illustrative implementations;

FIG. 3A is a summary of a set of fields contained in an exemplary information transmission containing information pertaining to a recharging event, including information from which recharging station electrical infrastructure status may be derived;

FIG. 3B identifies a set of tables maintained within a recharging station database populated by data extracted from the information transmission fields summarized in FIG. 3A relating to recharging events occurring at recharging stations and well as information rendered by a recharge station server relating to the recharging stations;

FIG. 4 is a sequence diagram summarizing an exemplary method for acquiring/maintaining recharging station electrical infrastructure status information in a recharging station database comprising information pertaining to recharging events at various recharging stations; and

FIG. 5 is a flow chart summarizing operations for an exemplary method for processing information pertaining to recharging events stored in a database to render a status alert pertaining to electrical infrastructure for users/operators of a particular recharging station.

### DETAILED DESCRIPTION OF THE DRAWINGS

Before discussing the details of the invention and the environment wherein the invention may be used, a brief overview of an exemplary telematics system is given to guide the reader. In general terms, not intended to limit the claims, the invention is directed to a system and method for maintaining a recharging station electrical infrastructure status database that is updated based on a population of electric vehicles equipped with telematics units providing information, from which electrical infrastructure status may be determined, acquired during the recharging of the vehicles. Information, passed on by the individual vehicles' telematics systems, relating to commercial/public/private electric vehicle recharging stations' electrical infrastructure is maintained in the recharging station electrical infrastructure status database. Information relating to electrical infrastructure obtained during recharging events at private recharging facilities may be used to alert private owners of potential damage to their private/residential electrical power system. However, such information is not pertinent to the public. As such, the contents of the recharging station electrical infrastructure status database are distinguished based upon whether the recharging station is public or private.

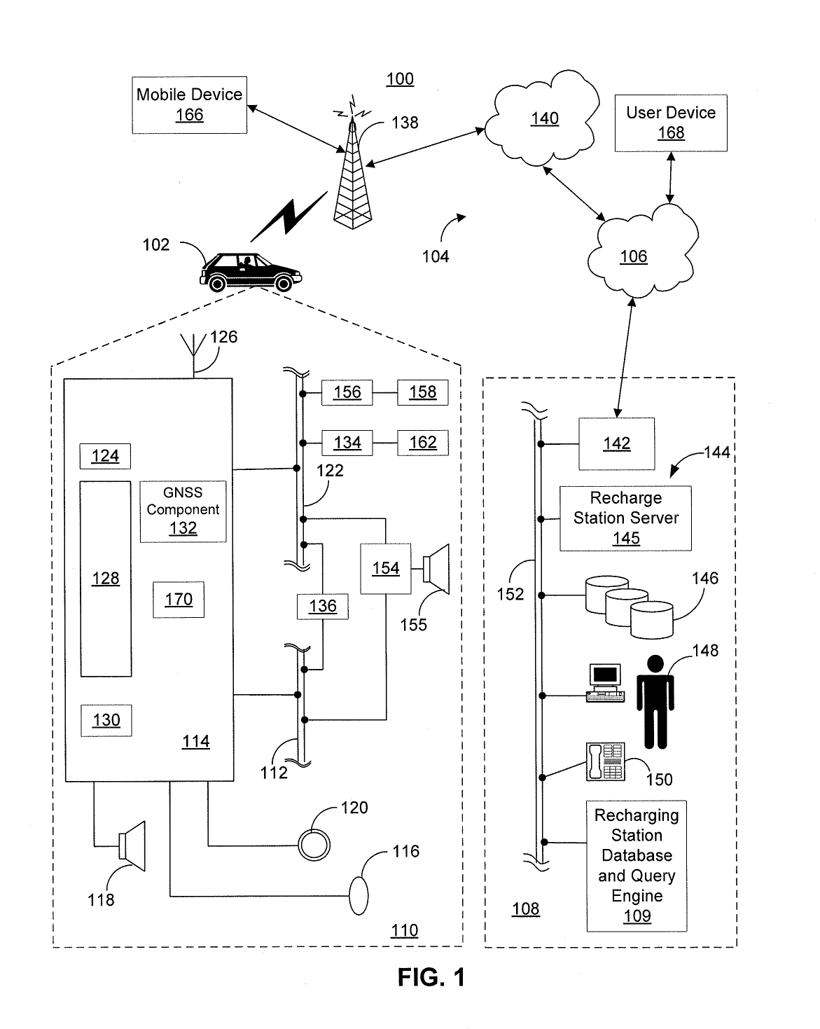

An exemplary computing and network communications environment is described hereinafter. It will be appreciated that the described environment is an illustrative example, and does not imply any limitation regarding the use of other environments to practice the invention. With reference to FIG. 1 there is shown an example of a communication system 100 that may be used with the present method and system to pass vehicle and driver information. The communication system 100 generally includes a vehicle 102, a mobile wireless network system 104, a land network 106 and a communications center 108. It should be appreciated that the overall architecture, setup and operation, as well as the individual components of the communication system 100 is generally known in the art.

In accordance with an illustrative example, the communications center 108 includes a recharging station electrical infrastructure status database and query engine (database and query engine) 109. The database and query engine 109, incorporating functional components facilitating updates to vehicle and/or user tables maintained on the database and query engine 109 that contains information relating to the operational status of recharging station electrical infrastructure based upon operating parameter values acquired by electricity powered vehicles during recharging. The database and query engine 109 maintains a multitude of both current status information as well as historical information upon which electrical infrastructure status rating criteria are applied to render current status ratings and, if necessary, issue maintenance alerts to operators of malfunctioning/damaged/improperly configured recharging stations. Such status ratings include ratings for private owners as well as public recharging station operators. Additionally, a variety of warning/alert types are contemplated. Such warnings/alerts are based upon a variety of diagnostic operations applied to the contents of the recharging station electrical infrastructure status information stored by the database and query engine 109.

The vehicle 102 is, for example, a motorcycle, a car, a truck, a recreational vehicle (RV), a boat, a plane, etc. The vehicle 102 is equipped with suitable hardware and software that configures/adapts the vehicle 102 to facilitate communications with the communications center 108 via mobile wireless communications. The vehicle 102 includes hardware 110 such as, for example, a telematics unit 114, a microphone 116, a speaker 118 and buttons and/or controls 120 integrated with the telematics unit 114. In a warning mode of operation of the telematics unit 114, the speaker 118 is used to issue an audible warning/alert to a user when a notification is received from the communications center 108, via the communications system 100, that a currently used charger is connected to a defective/malfunctioning electrical infrastructure.

The telematics unit 114 is communicatively coupled, via a hard wire connection and/or a wireless connection, to a vehicle bus 122 for supporting communications between electronic components within the vehicle 102. Examples of suitable network technologies for implementing the vehicle bus 122 in-vehicle network include a controller area network (CAN), a media oriented system transfer (MOST), a local interconnection network (LIN), an Ethernet, and other appropriate connections such as those that conform with known ISO, SAE, and IEEE standards and specifications.

The telematics unit 114 provides a variety of services through communications with the communications center 108. The telematics unit 114 includes an electronic processor 128, electronic memory 130, a mobile wireless component 124 including a mobile wireless chipset, a dual function antenna 126 (both GNSS and mobile wireless signal), and a GNSS component 132 including a GNSS chipset. In one example, the mobile wireless component 124 comprises an electronic memory storing a computer program and/or set of computer-executable instruction sets/routines that are transferred to, and executed by, the processing device 128. The mobile wireless component 124 constitutes a network access device (NAD) component of the telematics unit 114.

The telematics unit 114 provides, for users, an extensive/extensible set of services. Examples of such services include: GNSS-based mapping/location identification, turn-by-turn directions and other navigation-related services provided in conjunction with the GNSS component 132; and airbag deployment notification and other emergency or roadside assistance-related services provided in connection with various crash and or collision sensor interface modules 156 and crash sensors 158 located throughout the vehicle. The telematics unit 114 also supports receiving and forwarding to a multi-user vehicle database and query engine 109, via the mobile wireless component 124, a variety of sensor readings relating to operation of the vehicle 102.

The telematics unit 114 is an onboard device providing a variety of services through its communication with the call center 108, and generally includes an electronic processing device 128, one or more types of electronic memory 130, a cellular chipset/component 124, a wireless modem 126, a dual antenna 160 and a navigation unit containing a GPS chipset/component 132. In one example, the wireless modem 126 comprises, and is carried out in the form of, a computer program and/or set of software routines executing within the electronic processing device 128. The cellular chipset/component 124 and the wireless modem 126 may be called the network access device (NAD) of the telematics unit 114.

The telematics unit 114 further includes a short-range wireless unit 170 capable of communicating with a user's mobile device such as a cellular phone, tablet computer, PDA, or the like, over a short-range wireless protocol. For example, in one implementation, the short-range wireless unit 170 is a Bluetooth unit with an RF transceiver that communicates with a user's mobile device using Bluetooth protocol.

The short-range wireless unit 170 is adapted to communicate with communication devices maintained by a recharging station to provide information relating to a vehicle recharging event. For example, in an implementation, the short-range wireless unit 170 is a Bluetooth unit with an RF receiver that communicates with a recharging station using Bluetooth protocol. It will be appreciated that other short-range wireless communication technologies other than Bluetooth are used in other implementations. The information provided by the recharging station to the telematics unit via the short-range wireless unit 170 is passed to, for example, the database and query engine 109 configured to maintain a searchable storehouse of recharging station event information.

GNSS navigation services are, for example, implemented based on the geographic position information of the vehicle provided by the GNSS component 132. A user of the telematics unit 114 enters a destination, for example, using inputs associated with the GNSS component 132, and a route to a destination may be calculated based on the destination address and a current position of the vehicle determined at approximately the time of route calculation. Turn-by-turn (TBT) directions may further be provided on a display screen corresponding to the GNSS component and/or through vocal directions provided through a vehicle audio component 154. It will be appreciated that the calculation-related processing may occur at the telematics unit or may occur at a communications center 108.

The telematics unit 114 also supports infotainment-related services whereby music, Web pages, movies, television programs, video games and/or other content is downloaded by an infotainment center 136 operatively connected to the telematics unit 114 via the vehicle bus 122 and an audio bus 112. In one example, downloaded content is stored for current or later playback.

The above-listed services are by no means an exhaustive list of the current and potential capabilities of the telematics unit 114, as should be appreciated by those skilled in the art. The above examples are merely a small subset of the services that the telematics unit 114 is capable of offering to users. Moreover, the telematics unit 114 includes a number of known components in addition to those listed above that have been excluded since they are not necessary to understanding the functionality discussed herein below.

The telematics unit 114 uses radio transmissions to establish communications channels with the mobile wireless network system 104 so that voice and/or data signals, including ones containing data corresponding to one or more events used to calculate a vehicle and/or driver rating, can be sent and received via the communications channels. The mobile wireless component 124 enables both voice and data communications via the mobile wireless network system 104. The mobile wireless component 124 applies encoding and/or modulation functions to convert voice and/or digital data into a signal transmitted via the dual function antenna 126. Any suitable encoding or modulation technique that provides an acceptable data rate and bit error can be used. The dual function antenna 126 handles signals for both the mobile wireless component 124 and the GNSS component 132.

The microphone 116 provides the driver or other vehicle occupant with an interface for inputting verbal or other auditory commands to the telematics unit 114, and can be equipped with an embedded voice processing unit utilizing a human/machine interface (HMI) technology known in the art. The speaker 118 provides verbal output to the vehicle occupants and can be either a stand-alone speaker specifically dedicated for use with the telematics unit 114 or can be part of an audio component 154. In either case, the microphone 116 and the speaker 118 enable the hardware 110 and the communications center 108 to communicate with occupants of the vehicle 102 through audible speech.

The hardware 110 also includes the buttons and/or controls 120 for enabling a vehicle occupant to activate or engage one or more components of the hardware 110 within the vehicle 102. For example, one of the buttons and/or controls 120 can be an electronic push button used to initiate voice communication with the communications center 108 (whether it be live advisors 148 or an automated call response system). In another example, one of the buttons and/or controls 120 initiates/activates emergency services supported/facilitated by the telematics unit 114.

The audio component 154 is operatively connected to the vehicle bus 122 and the audio bus 112. The audio component 154 receives analog information via the audio bus, and renders the received analog information as sound. The audio component 154 receives digital information via the vehicle bus 122. The audio component 154 provides AM and FM radio, CD, DVD, and multimedia functionality independent of the infotainment center 136. The audio component 154 may contain a speaker system 155, or may utilize the speaker 118 via arbitration on the vehicle bus 122 and/or the audio bus 112.

The vehicle crash and/or collision detection sensor interface 156 is operatively connected to the vehicle bus 122. The crash sensors 158 provide information to the telematics unit 114 via the crash and/or collision detection sensor interface 156 regarding the severity of a vehicle collision, such as the angle of impact and the amount of force sustained.

A set of vehicle sensors 162, connected to various ones of a set of sensor interface modules 134 are operatively connected to the vehicle bus 122. Examples of the vehicle sensors 162 include but are not limited to gyroscopes, accelerometers, magnetometers, emission detection and/or control sensors, and the like. Examples of the sensor interface modules 134 include ones for power train control, climate control, and body control. Data from the sensor interface modules 134 is provided to automobile electronic control units, including an engine control unit (ECU), not shown in FIG. 1.

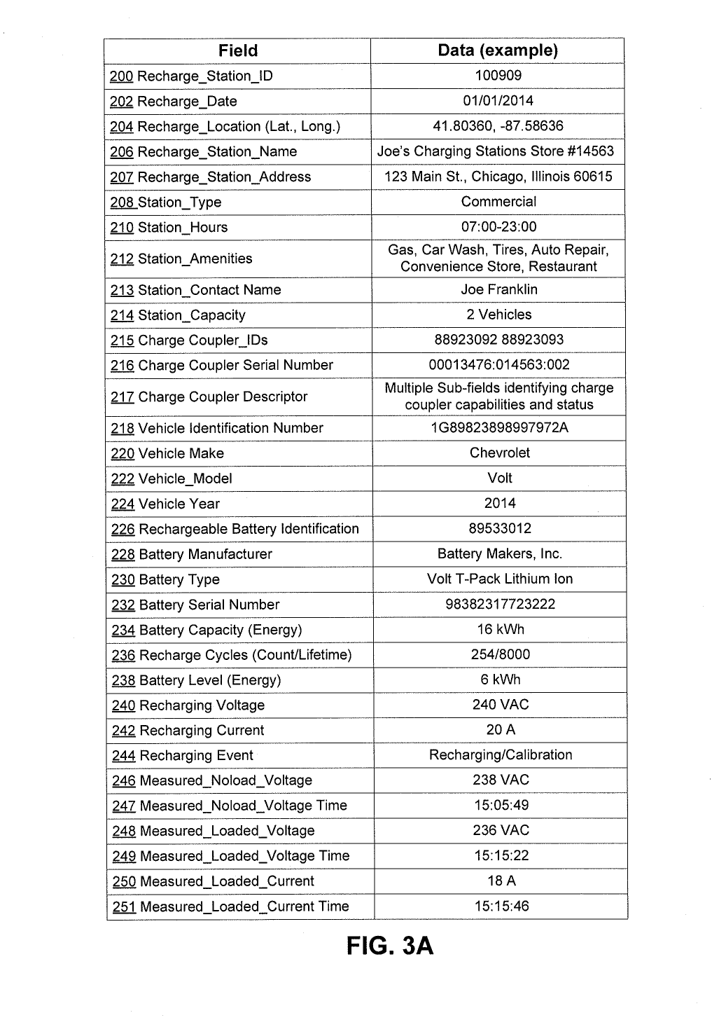

Furthermore, in accordance with an illustrative example, recharging event data (e.g., recharge voltage measured at the vehicle/charger interface before and during recharging) are provided by the sensor interface modules 134 (either directly via the vehicle bus 122 or indirectly via the ECU) to the telematics unit 114. By way of example, the telematics unit 114 selectively processes and forwards signal values acquired via the sensors 162, in accordance with a configured signal data acquisition/filtering scheme, to the database and query engine 109. The forwarded signal values are received by, for example, a recharge station health status server (recharge station server) 145 in a recharge message. See FIG. 3A (described below). The recharge station server 145 thereafter extracts and submits the received signal values via database request messages to the database and query engine 109. Examples of the types of information passed to the database and query engine 109 are described herein below with reference to FIG. 3A.

The mobile wireless network system 104 is, for example, a cellular telephone network system or any other suitable wireless system that transmits signals between mobile wireless devices, such as the telematics unit 114 of the vehicle 102, and land networks, such as the land network 106. In the illustrative example, the mobile wireless network system 104 includes a set of cell towers 138, as well as base stations and/or mobile switching centers (MSCs) 140, as well as other networking components facilitating/supporting communications between the mobile wireless network system 104 with the land network 106. For example, the MSC 140 includes a remote data server.

As appreciated by those skilled in the art, the mobile wireless network system includes various cell tower/base station/MSC arrangements. For example, a base station and a cell tower could be co-located at the same site or they could be remotely located, and a single base station could be coupled to various cell towers or various base stations could be coupled with a single MSC, to name but a few of the possible arrangements.

Land network 106 can be, for example, a conventional land-based telecommunications network connected to one or more landline end node devices (e.g., telephones) and connects the mobile wireless network system 104 to the communications center 108. For example, land network 106 includes a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

The communications center 108 is configured to provide a variety of back-end services and application functionality to the hardware 110. The communications center 108 includes, by way of example, network switches 142, servers 144 (including the recharge station server 145), databases 146, live advisors 148, as well as a variety of other telecommunications equipment 150 (including modems) and computer/communications equipment known to those skilled in the art. These various call center components are, for example, coupled to one another via a network link 152 (e.g., a physical local area network bus and/or a wireless local network, etc.). Switch 142, which can be a private branch exchange (PBX) switch, routes incoming signals so that voice transmissions are, in general, sent to either the live advisors 148 or an automated response system, and data transmissions are passed on to a modem or other component of the telecommunications equipment 150 for processing (e.g., demodulation and further signal processing).

The servers 144, as noted above, include the recharge station server 145. By way of example, the recharge station server 145 is configured with an Internet interface facilitating providing charge station status data services, to a variety of user/subscribers, specifying health status and availability of the charger outlets associated with the identified charge stations. In a typical scenario, recharging station owners specify a notification scheme wherein the recharge station server 145 queries the database and query engine 109 for pertinent recharging station status information, and forwards alerts to the station owner (or recharge station maintenance agent) notifying the owner/agent of a foreseeable/imminent/actual failure of an identified recharging station electrical infrastructure. The automated nature of the notification/alert message issuance procedure is dependent upon the vehicles to acquire and forward pertinent information acquired during recharging of the vehicles to the recharge station server 145 and then provide that information to a designated subscriber when the status of a particular recharge station electrical infrastructure indicates an actual/imminent failure of the supporting electrical infrastructure.

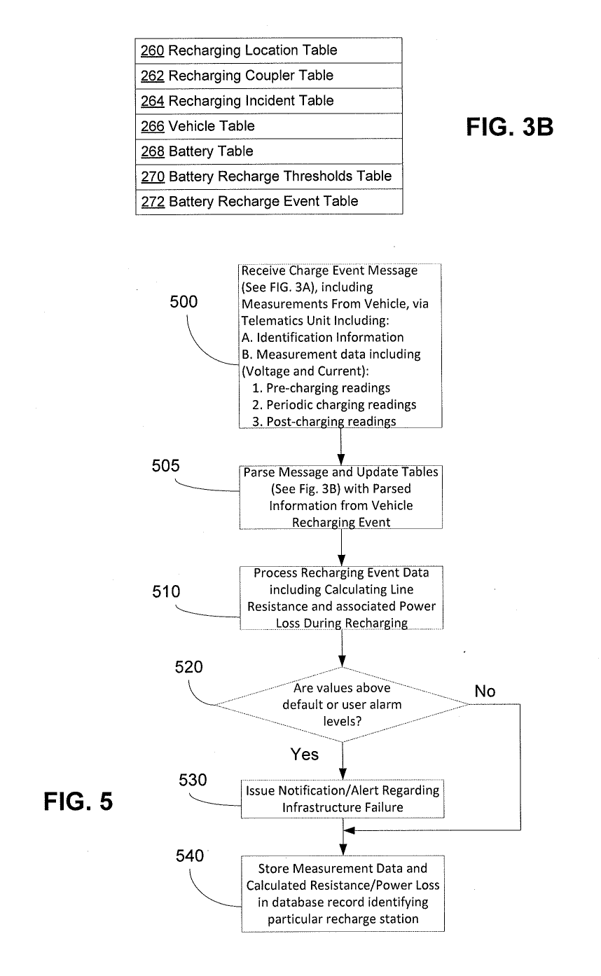

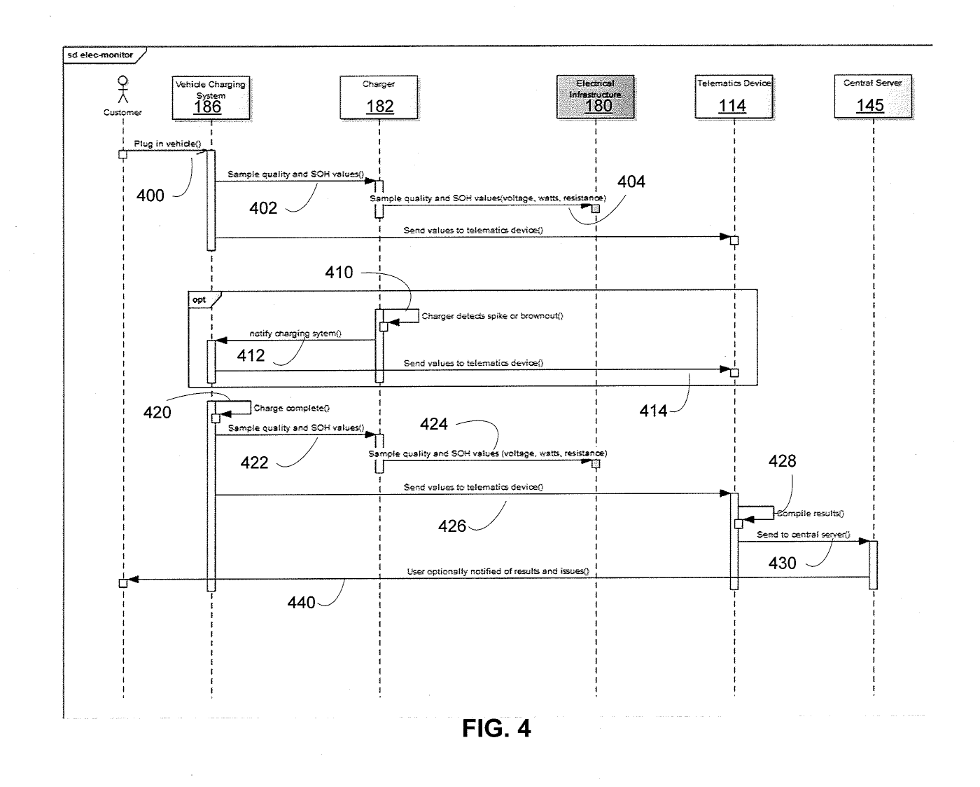

To that end, the recharge station server 145 is also configured with a database query interface facilitating submitting structured queries to the database and query engine 109 and receiving/processing subsequent responsive recharging station status data. In general, the recharge station server 145 also responds to requests from users, acquires relevant data from the tables maintained by the database and query engine 109, applies specified alert/warning criteria to the acquired data, and renders responsive alerts/warning to the requesting users with regard to identified recharging stations. The functionality of the recharge station server 145, including exemplary status detection/reporting algorithms, are described, by way of example herein below, with reference to FIGS. 4 and 5.

The telecommunications equipment 150 includes, for example, an encoder, and can be communicatively connected to various devices such as the servers 144 and the databases 146. For example, the databases 146 comprise computer hardware and stored programs configured to store subscriber profile records and other pertinent subscriber information. Although the illustrated example has been described as it would be used in conjunction with a manned version of the communications center 108, it will be appreciated that the communications center 108 can be any of a variety of suitable central or remote facilities, which are manned/unmanned and mobile/fixed facilities, to or from which it is desirable to exchange voice and data.

It will be appreciated by those of skill in the art that the execution of the various machine-implemented processes and steps described herein may occur via the computerized execution of computer-executable instructions stored on a tangible computer-readable medium, e.g., RAM, ROM, PROM, volatile, nonvolatile, or other electronic memory mechanism. Thus, for example, the operations performed by the telematics unit may be carried out according to stored instructions or applications installed on the telematics unit, and operations performed at the call center may be carried out according to stored instructions or applications installed at the call center.

The database and query engine 109 maintains information pertaining to a plurality of recharging stations and associated vehicle battery recharging events. Each time a vehicle is recharged, the vehicle sensors 162, through sensor interface modules 134 and operatively connected to the vehicle bus 122, determine that a recharging event is taking place or has just occurred and that the vehicle has been recharged. Upon determining that a recharging event is taking place, the telematics unit 114 receives and monitors information pertaining to the recharging event from the vehicle sensors 162. For example, through vehicle sensors 162 and sensor interface modules 134, the telematics unit can determine the times at which a recharging event begins and ends and the charge level of the vehicle's battery during the recharging event. In this way, during the charging event, the telematics unit may acquire, as a function of time, the electrical energy being supplied via the charge coupler into the battery, the charge level of the battery, and other measurements related to the recharging event.

Depending upon the type of connection the vehicle is able to achieve with the recharging station, additional information originating from the recharging station is obtained by the telematics unit 114. This information includes the throughput and power output of the of the recharging station, the price paid per unit (e.g., kW hour) for recharging, the hours of operation of the commercial recharging station, the station's customer flow, the vehicle capacity of the station, the identity of the specific charge coupler to which the vehicle is connected, and other information related to the recharging event.

Importantly, in particular illustrative examples, the telematics unit acquires data relating to the operational health of the electrical infrastructure supporting the charger through which the vehicle is being charged. Such operational health information includes, by way of example, no-load (pre-charging) voltage, recharging current, recharging voltage, etc. For each voltage and current reading, supplemental/contextual information is also acquired by the telematics unit for forwarding to the recharge station server 145 such as: a station ID, a charger ID, a timestamp, recharge level, etc.

In another example, the telematics unit 114 comprises additional communication hardware that enables the telematics unit 114 to communicate with compatible communication equipment at the recharging station. For example, upon receiving an indication from the vehicle sensors 162 that a recharging event is occurring, the telematics unit seeks to connect with external devices supported and maintained by a recharging station. A communication link between these external devices and the telematics unit is provided over: (1) hardwired “control pilot signal” (reference J1772 specification—publicly available), and/or (2) a short-range wireless technology such as Bluetooth, Wi-Fi, ZigBee, and RFID amongst others. The telematics unit 114 requests a variety of information from the external devices including but not limited to the throughput and power output of the of the recharging station charger unit to which the recharging vehicle is connected, the price paid per unit (e.g., kW hour) during recharging, the hours of operation of the station, the station's customer flow, the vehicle capacity of the recharging station (e.g., the number of recharger units/outlets), etc.

The telematics unit 114 may also merely request a connection with the external device and passively receive information from the device or the telematics unit 114 may passively receive a request for a connection from the external device. For example, the telematics unit may be able to identify external devices maintained by a recharging station and attempt to connect with such devices upon becoming in range or the external device may identify and attempt to connect to all telematics units that come within its range. Upon receipt of any such information from the external device, the telematics unit 114 aggregates information pertaining to the recharging event and sends it to the recharge station server 145 for processing and storing on the database and query engine 109. Alternatively, communication equipment at the recharging station sends information to the recharge station server 145 and thereby communicates directly with the communications center 108 rather than rely upon the telematics unit 114 of the recharging vehicle. The information provided in association with the recharge event can be used for a variety of uses. For example, the price paid per unit may be transmitted via a long range network link to the recharge station server 145 for comparison/verification of the provided price paid per unit.

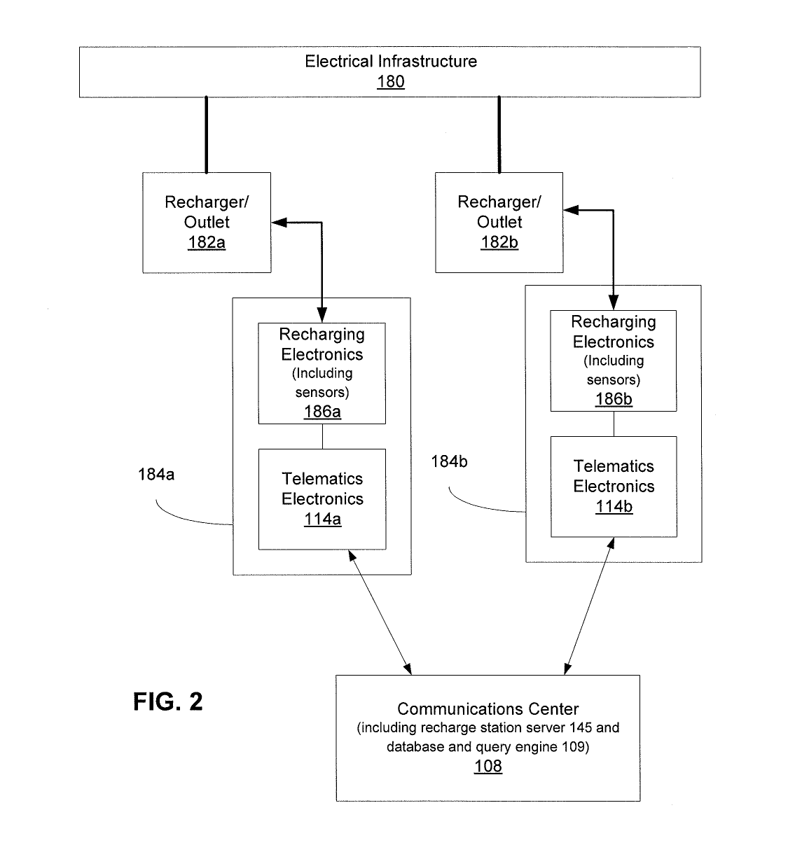

FIG. 2 provides an illustrative schematic diagram of a recharging station including rechargers (outlets) 182a and 182b, to which electric vehicles 184a and 184b are connected to carry out a recharging operation on their respective rechargeable battery units. The exemplary recharging station includes an electrical infrastructure 180. When in use, the rechargers 182a, 182b together, at peak, draw substantial current at relatively high voltage from the electrical infrastructure 180. For example, a typical level 2 AC recharge installation operates at 240 Volts (peak-to-peak) and 60 Amps, resulting in a power consumption rate of 6.6 kW. However, DC “fast charge” units may draw power an order of magnitude greater than level 2 rechargers. As such, the electrical infrastructure 180 may need to be configured to handle the relatively high peak current/power demand associated with situations where multiple chargers are simultaneously charging electric vehicles. For example, a heavier gauge wiring may be needed within the electrical infrastructure 180 to reduce line resistance when, for example, both of the rechargers 182a and 182b are drawing power during the recharging of the battery units within the electric vehicles 184a and 184b. Moreover, the higher power drawn from the electrical infrastructure 180 may, over time, wear out parts that would otherwise last indefinitely.

To aid detection of potential configuration faults and/or failure of the electrical infrastructure 180 relating to the high potential power drawn by recharging vehicles, the telematics electronics 114a, 114b within electric vehicles 184a and 184b, respectively, are configured to obtain a variety of recharging parameter values acquired by the recharging electronics 186a, 186b while connected to rechargers 182a, 182b. The recharging parameter types, for example, include: charging station ID, recharger ID, open circuit/no-load voltage (before commencing recharging), recharging voltage (after commencing recharging), and recharging current. The voltage, current, and power are potentially sampled several times during a given recharging operation for a vehicle. The telematics electronics 114a, 114b forward their respective acquired recharging parameter values to the communications center 108. More particularly, the recharging parameter values are forwarded to the recharging station server 145. The recharge station server 145 thereafter submits requests to the database and query engine 109 to commit the recharging parameter values to appropriate tables maintained by the database and query engine 109. Thus, the recharge station server 145 coordinates the storing of historical recharging data, provided via vehicle telematics units, for later diagnostic analysis. Such diagnostic analysis is carried out by the recharge station server 145 to identify potential, impending, and actual failures of the electrical infrastructure 180 supplying power for the rechargers 182a, 182b. An example of message contents from the telematics electronics 114a, 114b to the communications center 108 is described below with reference to FIG. 3A.

FIG. 3A comprises an exemplary set of data (payload) fields within a transmitted message from the telematics electronics 114a, 114b to the recharge station server 145. The data fields within the message summarize a recharging and/or calibration event for an identified electric vehicle at an identified recharge coupler (outlet) of an identified recharging station/location. A portion of the information contained in the transmission is provided by the recharging electronics 186a, 186b to the telematics electronics 114a, 114b before, during and/or after recharging the electric vehicles 184a, 184b. The values within the fields of information can originate from on-vehicle electronics and/or from equipment at the recharging station where the recharging occurred. The transmission is sent from the telematics units 114a, 114b or, alternatively from communication equipment at the recharging station.

In the exemplary information, contained within a transmitted message, depicted in FIG. 3A, a set of fields provide general context information relating to a particular recharging station, wherein the recharging station may comprise one or more charge couplers—the charge couplers being the actual charging interface structures through which power is delivered to a vehicle during recharging. A RECHARGE_DATE 202 contains information pertaining to the date on which the recharging event took place. In this example, the RECHARGE_DATE 202 field is a data structure with elements for the month, day, and year on which the recharging event took place. A RECHARGE_LOCATION 204 provides the geographical coordinates at which the recharging event occurred and in the exemplary transmission is a data structure with elements for the latitude coordinate and longitude coordinate. A RECHARGE_STATION_NAME 206 provides the name of the recharging station, and a RECHARGE_STATION_ADDRESS 207 provides an address of the recharging station. A STATION_TYPE 208 indicates whether the station is a residential location, commercial location, or some other category of recharging location. A STATION_HOURS 210 provides the hours of operation of the recharging station and in the exemplary information transmission is a data structure with elements for the time at which the recharging station opens and for the time at which the station closes. A STATION_AMENITIES 212 lists other goods and services that the recharging station and businesses affiliated with the recharging station provides. For example, if recharging charge couplers (outlets) are located at a supermarket parking lot, the STATION_AMENITIES 212 indicates that a supermarket is located at the recharging station. A STATION_CAPACITY 214 indicates a number of charge couplers located at the identified recharging station.

Continuing the description of FIG. 3A fields within the exemplary message structure are directed to providing information relating to a particular recharge station charge coupler to which a vehicle is attached during a recharging/calibration event of interest. A CHARGE COUPLER IDs 215 comprises a list of globally unique hardware-independent values assigned to each one of potentially many charge coupler stalls/positions at a particular recharge station identified by the RECHARGE_STATION_ID 200. Additionally, an indication of the particular one of the potentially multiple charge couplers that was actually used to perform recharging is identified within the charge coupler IDs 215. A CHARGE COUPLER SERIAL NUMBER 216 provides a unique identifier for the charge coupler at which the recharging event occurred. In the exemplary transmission, the CHARGE COUPLER SERIAL NUMBER 216 contains an identifier of the particular charge coupler used by the vehicle at the recharging station during the recharging/calibration event corresponding to the message information. A CHARGE COUPLER DESCRIPTOR 217 comprises multiple sub-fields containing information further describing the particular charge coupler. In particular, the CHARGE COUPLER DESCRIPTOR 217 includes: manufacturer name/identification/address/contact, model name/number, supported charge modes (e.g. 10 A/120 VAC, 20 A/240 VAC), supported connectors (e.g. J1772), last maintenance date, first operational date, status (e.g., out-of-service, operational, etc.), and incident identification (e.g., incident number/date/error type).

A further set of fields in the recharge information message transmitted to the recharge station server identify a vehicle that issued the information message. A VEHICLE IDENTIFICATION NUMBER (VIN) 218 uniquely identifies the vehicle from which the recharging information pertains/originates. A vehicle make 220 (e.g. CHEVROLET) and a vehicle model 222 (e.g. VOLT) are also provided in the exemplary recharging information message payload. A vehicle year 224 identifies a model year of the recharging vehicle.

Similarly, fields are provided to identify and describe the rechargeable battery within the identified vehicle. A battery identification 226 provides a unique number assigned to the battery within the database (assigned by database 109 at the time of creation of the battery record for this particular battery. Additional information provided with the battery identification 226 enable definitive identification of particular batteries—even if the battery is reinstalled in another vehicle. A battery manufacturer 228 identifies a maker of the battery. The battery may further be identified by a battery type 230 specifying a generic description and/or model name of the identified battery. A battery serial number 232 is a unique alphanumeric value assigned to the battery by the manufacturer. A battery capacity 234 specifies an estimated stored energy capacity of the fully charged identified battery. A charge cycles 236 specifies a number of times the identified battery has been recharged.

A further set of fields within the recharging event information message from the vehicle includes data relating to the recharging operation including charge station capabilities and actual observed measurements. A BATTERY LEVEL 238 indicates a battery power level at the time of commencing charging. A RECHARGING_VOLTAGE field 240 indicates the maximum available voltage of the charge coupler. A RECHARGING_CURRENT 242 indicates a maximum recharging current that the identified recharge coupler is capable of delivering during recharging. The RECHARGING_VOLTAGE 240 and RECHARGING_CURRENT 242 contain values specifying the advertised/negotiated maximum values. As such, these two values may be used to determine whether a particular charge coupler is operating properly (by having the vehicle request the maximum voltage and/or current and then measure the subsequent voltage and/or current delivered by the recharging interface. An EVENT 244 specifies whether the provided voltage/current measures are associated with a calibration event (no load) or recharging event (load).

Additional fields depicted in FIG. 3A store particular measurements acquired during recharging to determine a health status of the electrical infrastructure 180 providing power to the recharger through which the electrical vehicle batteries are being recharged. A MEASURED_NOLOAD_VOLTAGE 246 stores a voltage value measured/acquired during a point in time within a recharging operation where recharging is interrupted so that no power is being delivered to the batteries of a recharging vehicle. An associated MEASURED_NOLOAD_VOLTAGE TIME 247 stores a timestamp corresponding to the time of taking the noload voltage reading. A second voltage reading, stored in a MEASURED_LOADED_VOLTAGE 248, corresponds to a voltage measurement acquired while the recharger is delivering power to the battery unit of the recharging vehicle. An associated MEASURED_LOADED_VOLTAGE TIME 249 stores a timestamp corresponding to the time of taking the loaded voltage reading. A current reading, stored in a MEASURED_LOADED_CURRENT 250, corresponds to a current measurement acquired while the recharger is delivering power to the battery unit of the recharging vehicle. An associated MEASURED_LOADED_CURRENT TIME 251 stores a timestamp corresponding to the time of taking the loaded current reading. These voltage/current measurements are utilized by the recharge station server 145 to detect a potential or actual problem with a configuration of an electrical infrastructure (e.g., infrastructure 180) supplying power to a recharger (e.g., recharger 186a) during recharging of a vehicle (e.g., electric vehicle 184a).

It will be appreciated that FIG. 3A is not an exhaustive listing of fields within a message, provided to the recharge station server 145, relating to a recharging event, nor does it constitute a list of required fields. Many other fields may be included in the database records relating to recharging stations and associated recharging events. Moreover, some of the fields included in the exemplary message may take the form of different data structures or data types. For example, multiple, repeated voltage/current measurements taken during recharging could be transferred once in a single data structure including several (thousands) of data measurement points, where data points for each measurement field are obtained at a high frequency, e.g. 1 kHz. At a frequency of 1 kHz, 3.6 million data points for the recharging throughput and battery levels during a 1 hour recharging event. The frequency at which data points are obtained could be adjusted to achieve an optimal balance between monitoring the pace of recharging and dealing with data storage limitations.

Turning to FIG. 3B a set of tables containing information relating to recharging stations and associated recharging events are identified. A recharging location table 260 stores a set of records describing registered recharging locations. Each location may comprise a number of charge couplers (see recharging coupler table 262 below). By way of example, each recharging location table entry includes information corresponding to: the recharge station identification 200, recharge location 204, recharge station name 206, recharge station address 207, station type 208, station hours 210, station amenities 212, station contact name 213, station capacity 214, and charge coupler identifications 215 (one for each charge coupler at the station).

A recharging coupler table 262 stores a set of records describing registered charge couplers. By way of example, each recharge coupler table entry includes information corresponding to: a recharge coupler identification taken from the charge coupler identifications 215, recharging location identification 200, charge coupler serial number 216, and charge coupler descriptor information 217 (including the currently assigned operational status/state of health). Each identified recharging coupler record also includes a link to a reservation/use schedule for the particular charge coupler/station. The recharging coupler table 262 also identifies a last recorded incident identification.

A recharging coupler incident table 264 stores a set of records describing registered incidents. By way of example, each incident table record includes information corresponding to: an identification of the recharge coupler that experienced the incident, the type of incident (brown out, total power loss, etc.), and a timestamp.

A vehicle table 266 stores a set of records describing registered vehicles. By way of example, each vehicle table record includes information corresponding to: vehicle identification number 218, vehicle make 220, vehicle model 222, vehicle year 224, and rechargeable battery identification 226.

A battery table 268 stores a set of records describing registered battery units. By way of example, each battery unit table record includes information corresponding to: battery identification 226, battery manufacturer 228, battery type 230, battery serial number 232, battery capacity 234, and recharge cycles 236.

A recharge thresholds table 270 stores a set of records describing the alarm/warning/action threshold values for an identified charge coupler (or charge coupler type/model). By specifying thresholds at an individually identified charge coupler level of granularity, customized (owner-specified) thresholds are supported. By way of example, the thresholds table 270 records each specify information corresponding to: a charge coupler identification (identifying a particular charge coupler or some other identifier such as a location/station identification, a charge coupler model, etc.), a number of recharge cycles (of the station), a measured current variance from full negotiated current, and a maximum permitted noload/loaded voltage drop off. The contents of the recharge thresholds table 270 are generated during a configuration period when new charge couplers are registered with the recharge station server 145.

A battery recharge event table 272 stores a set of records describing various recharge/calibration events described in the recharge event information messages (see FIG. 3A) received by the server 145 from vehicles. By way of example, the recharge event records 272 contain information corresponding to: vehicle identification number 218, recharge station 200, charge coupler identification (indicated one within the charge coupler IDs 215); battery level 238, recharging voltage 240, recharging current 242, recharging event type 244, measured no load voltage 246, no load voltage time 247, measured loaded voltage 248, loaded voltage time 249, measured loaded current 250 and loaded current time 252.

Turning to FIG. 4, a sequence diagram depicts an exemplary sequence of operations relating to measurement of operating parameters of a recharging station to facilitate identifying faulty wiring or other problems with electrical infrastructure providing power to electric vehicle rechargers. Initially, at 400, a customer connects a charge coupler of the recharger 182a to the recharging electronics 186a of the electric vehicle 184a. Thereafter, during 402, the recharging electronics 186a issue a request to the charger 182a to acquire voltage and current measurements corresponding to the data in the Measured_Noload_Voltage field 236, the Measured_LoadedVoltage field 238, and the Measured_Loaded_Current field 240. The recharger 182a, during 404, acquires the requested measurements of the electrical infrastructure 180 on behalf of the recharging electronics 186a and provides the initial measurements to the recharging electronics 186a. The recharging electronics 186a, during 406, forward the measured voltages and current to the telematics electronics 114a for forwarding to the recharging station server 145. In the illustrative embodiment, the initial measurements are held by the telematics electronics while the recharging operation completes, and the initial measurements are packaged with other information (see FIG. 3A described above) in a single message to the recharging station server 145. Alternatively (or additionally), the initial measurements (corresponding to fields 236, 238 and 240 of the example message format) are forwarded immediately to the recharging station server 145. Such immediate transmission would occur for example, in response to detection of a severe problem with the electrical infrastructure 180 during the initial measurement acquisition stage.

With continued reference to FIG. 4, while the batteries of the electrical vehicle 184a are charging, the recharger 182a may detect, during 410, an abnormality in the power supplied by the electrical infrastructure 180 (e.g., a voltage spike, brownout/voltage drop), etc.). The recharger 182a issues a notification to the recharging electronics 186a regarding the abnormality during 412, and during 414 the abnormality notification is passed to and registered by the telematics electronics 114a. The abnormality is either held and later forwarded upon completion of the recharging session, or alternatively issued immediately by the telematics electronics 114a to the recharging station server 145.

Continuing with the description of FIG. 4, at 420 a recharging session completes. In response, during 422, the recharging electronics 186a issue a request to the charger 182a to acquire voltage and current measurements corresponding to the data in the Measured_Noload_Voltage field 236, the Measured_Loaded_Voltage field 238, and the Measured_Loaded_Current field 240. The Measured_Noload_Voltage field 236 is populated by a voltage value determined from a measurement(s) taken before commencing charging. The Measured_Loaded_Voltage field 238 and the Measured_Loaded_Current field 240 are populated by voltage/current values (respectively) determined from measurements taken shortly after commencing charging—when power delivery is generally greatest. This “initial” set of 3 values is stored as a group. Additional No Load/Loaded measurement sets are acquired to render “trending” data sets during the course of a single recharging over an extended period of time and a various loading conditions (e.g., at low charge, partial charge, complete charge). The charger 182a, during 424, acquires the requested measurements of the electrical infrastructure 180 on behalf of the recharging electronics 186a and provides the initial measurements to the recharging electronics 186a. The recharging electronics 186a, during 426, forward the measured voltages and current to the telematics electronics 114a for forwarding to the recharging station server 145.

During 428, the telematics electronics 114a compile the information relating to the recharging session into a message to be passed to the recharging station (see FIG. 3A for example fields), and during 430 the message containing the compiled recharging session information to the recharging station server 145. While not shown in FIG. 4, the recharging station server 145 issues database requests to the database and query engine 109 to store the various pieces of information received in the message provided by the telematics electronics 114a during 430.

Additionally, the recharging station server 145 is configured to carry out a variety of diagnostic tests on the measurement values provided in the message received during 430. Moreover, the diagnostic tests may include additional measurement values provided by other telematics units relating to recharging sessions at a same recharger (or recharging station). In the illustrative embodiment, upon completing processing of the received measurement values in the message, during 440 the recharging station server issues an acknowledgement message. Such message may be sent directly to a user (e.g., an email, a text message, an audible warning via the telematics electronics 114a, etc.).

Example Calculation for Resistance:

(Open circuit voltage−loaded voltage)/loaded current

Example Computation for Power Lost During Charging:

((Loaded current̂2)*Calculated resistance)/(Loaded voltage*Loaded current)

Opportunity to Compare Values Measured Both:

1. between multiple charger units at the same location (value to the site owner)

2. between multiple charger units of the same size/spec/mfg at different locations, perhaps different owners.

This data becomes perhaps valuable to a third party who either manufactured this charge station model, or a fourth party who installs recharge station infrastructure.

An example of regulation would be national electric code sections 215.2(A) Informational wherein note #3 recommends no more than a 5% voltage drop at maximum power drawing load.

Turning to FIG. 5, operations and logical decisions are summarized with regard to receiving and processing, by the server 145, the information messages (see FIG. 3A) provided by vehicles in association with recharging/calibration events. Initially, during operation 500, the recharging station server 145 receives a recharge event message comprising information of the type summarized in FIG. 3A described herein above. Such information includes both identification and measurement data. With regard to the received measurement data, such information includes both pre-recharge (calibration) and recharging measurements (including potentially, post recharging readings). Thereafter, during operation 505, the server 145 parses the received information and issues requests to the database 109 to table the information extracted from the received message in the various tables described herein above with reference to FIG. 3B.

Additionally, with continued reference to FIG. 5, during operation 510 the server 145 processes the received measurements to gauge the state of health of the electrical infrastructure from which the recharging battery has drawn energy during the recharging operation associated with the received message information. As such, during operation 510 the server 145 acquires relevant threshold information from the battery recharge thresholds table 270, including for example an acceptable measured voltage drop between loaded and unloaded conditions (e.g. 50 volts drop for a 240 volt recharger coupler). Another potential threshold for detecting a malfunctioning or incorrectly configured electrical infrastructure is a difference (e.g. 8 A) between negotiated current (e.g. 20 A) and actual measured current during recharging.

After processing the measured voltage/current readings in view of provided thresholds during operation 510, during operation 520 the server 145 determines whether any threshold for issuing an electrical infrastructure health alert was reached/exceeded. Such thresholds include both ones relating to the actual measurements taken as well as ones relating to a running count or recharging cycles performed on a particular recharge coupler/station. If one or more alert threshold tests indicates a potential electrical infrastructure failure or substandard electrical infrastructure condition, then control passes to operation 530 wherein the server 145 issues a notification/alert regarding the potential electrical infrastructure health problem. Such alerts are, for example, issued to the telematics unit of the vehicle from which the information was received. The alerts are also forwarded via email, automated phone message, etc. to an identified contact for the location where the recharging event occurred. Additional destinations for such alerts include the manufacturer of the charge coupler/station. Control then passes to operation 540.

During operation 540 the server 145 stores any additional information generated during the processing of the measurements/thresholds during operation 510 in the database 109 (e.g. create/store a new incident description in the recharging incident table 264. If no alert conditions are detected during the processing operation 510 and determination operation 520, then control passes directly from operation 520 to operation 540. All recharge event measurements are stored during operation 505 (at least for a period of time), and thus the additional storing of information during operation 540 relates to any additional information arising from the processing of the raw information during operation 510 and to record notifications that occurred during operation 530.

The described system, and in particular the server 145 and database 109 facilitate conducting analyses upon aggregated events across potentially many distinct installations (station locations) to quickly identify design flaws in a particular system/installation type/configuration. For example, the server 145 can separately/additionally process aggregated data across multiple vehicles recharging at a particular station (charge coupler) to set maintenance intervals for charging couplers based on wear levels and charging efficiency gains determined by analyzing multiple sets of measurements provided by multiple vehicles over time. For example, it may be determined after analyzing a trend in load/no-load voltage differential readings over multiple recharging events, that refurbishing/servicing of a charge coupler is necessary after 10,000 recharge operations. Similarly, at 20,000 recharge operations, it may be necessary for a site operator to replace the charging cord for the particular charge coupler/station. The server 145 can detect when the cycle thresholds are reached and issue an appropriate alert to the station owner (and service/sales representative of the manufacturer).

Additionally, the server 145 and database 109 are utilized in the context of a recharging station availability/scheduling service (an aspect of the server 145 and related to the recharging coupler table 262). In that regard, when a particular station/coupler is determined to be malfunctioning, the station availability/scheduling records are updated to indicate the service state (non-operational) of the particular identified charge coupler.

While the above system is described in the context of electrical infrastructure state of health, similarly functionality can be built into conventional (gasoline) filing stations. In that case, fill-ups are recorded at particular pumps/stations, and trends can be identified in vehicle problems arising from poor quality/contaminated gasoline. When a particular number of incidents are recorded within a short period of time for a particular station, an alert is automatically issued to the station and any potentially affected vehicles.

It will be appreciated by those of skill in the art that the execution of the various machine-implemented processes and steps described herein may occur via the computerized execution of computer-executable instructions stored on a tangible computer-readable medium, e.g., RAM, ROM, PROM, volatile, nonvolatile, or other electronic memory mechanism. Thus, for example, the operations performed by the telematics unit may be carried out according to stored instructions or applications installed on the telematics unit, and operation performed at the call center may be carried out according to stored instructions or applications installed at the call center.

It is thus contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for maintaining a recharging station database for electric vehicles based upon recharging event data provided by electric vehicles equipped with telematics units, the method comprising the steps of:
receiving, by a recharging station server, recharging event information corresponding to a recharging event for an electric vehicle battery unit by an identified recharger, the recharging event information including at least a measurement relating to an electrical infrastructure providing power to the identified recharger;
processing, by the recharging station server, the recharging event information to render a diagnostic result relating to an electrical infrastructure providing power to the identified recharger; and
issuing an alert based upon a detected condition in the electrical infrastructure during the processing.

2. The method of claim 1 wherein the detected condition relates to power supply line impedance.

3. The method of claim 2 wherein the detected condition arises from a comparison of unloaded supply voltage and loaded supply voltage at a charge coupler interface during recharging of the electric vehicle battery unit by the identified recharger.

4. The method of claim 2 wherein the detected condition arises from a comparison of a maximum recharging current and a current measurement acquired during recharging the electric vehicle battery unit by the identified recharger.

5. The method of claim 1 wherein the diagnostic result relates to a count of recharging cycles performed at the identified recharger, and the recharging station server issues an alert in response to a comparison of the count of recharging cycles to a configured recharging count value.

6. The method of claim 1 wherein the issuing an alert includes sending a message to a telematics unit of a vehicle from which the recharging event information originated.

7. The method of claim 1 wherein the issuing an alert includes sending a message to an identified contact for a location of the identified recharger.

8. The method of claim 1 wherein the issuing an alert includes sending a message to an identified contact for a manufacturer of the identified recharger.

9. The method of claim 1 further comprising:
storing, by the recharging station server, the recharging event information in a database comprising a set of tables storing aggregated recharging event information for multiple recharges.

10. The method of claim 6 further comprising:
maintaining, by the recharging station server, an availability status of identified ones of recharging stations based at least in part upon the detected condition.

11. A non-transitory computer-readable medium including computer-executable instructions for maintaining a recharging station database for electric vehicles based upon recharging event data provided by electric vehicles equipped with telematics units, the computer-executable instructions, when executed by a processor of a computer system, facilitate performing the steps of:
receiving, by a recharging station server, recharging event information corresponding to a recharging event for an electric vehicle battery unit by an identified recharger, the recharging event information including at least a measurement relating to an electrical infrastructure providing power to the identified recharger;
processing, by the recharging station server, the recharging event information to render a diagnostic result relating to an electrical infrastructure providing power to the identified recharger; and
issuing an alert based upon a detected condition in the electrical infrastructure during the processing.

12. The computer-readable medium of claim 11 wherein the detected condition relates to power supply line impedance.

13. The computer-readable medium of claim 12 wherein the detected condition arises from a comparison of unloaded supply voltage and loaded supply voltage at a charge coupler interface during recharging of the electric vehicle battery unit by the identified recharger.

14. The computer-readable medium of claim 12 wherein the detected condition arises from a comparison of a maximum recharging current and a current measurement acquired during recharging the electric vehicle battery unit by the identified recharger.

15. The computer-readable medium of claim 11 wherein the issuing an alert includes sending a message to a telematics unit of a vehicle from which the recharging event information originated.

16. The computer-readable medium of claim 11 wherein the issuing an alert includes sending a message to an identified contact for a location of the identified recharger.

17. The computer-readable medium of claim 11 wherein the issuing an alert includes sending a message to an identified contact for a manufacturer of the identified recharger.

18. The computer-readable medium of claim 11 further comprising:
storing, by the recharging station server, the recharging event information in a database comprising a set of tables storing aggregated recharging event information for multiple recharges.

19. The computer-readable medium of claim 11 further comprising:
maintaining, by the recharging station server, an availability status of identified ones of recharging stations based at least in part upon the detected condition.

20. A recharging station server computer system for maintaining a recharging station database for electric vehicles based upon recharging event data provided by electric vehicles equipped with telematics units, the recharging station server computer system comprising:
a non-transitory computer-readable medium including computer-executable instructions; and
a processor configured to execute the computer-executable instructions to carry out a method comprising:
receiving, by the recharging station server, recharging event information corresponding to a recharging event for an electric vehicle battery unit by an identified recharger, the recharging event information including at least a measurement relating to an electrical infrastructure providing power to the identified recharger;
processing, by the recharging station server, the recharging event information to render a diagnostic result relating to an electrical infrastructure providing power to the identified recharger; and
issuing an alert based upon a detected condition in the electrical infrastructure during the processing.
